(19) United States
(12) Patent Application Publication
(10) Pub. No.: US 2025/0346453 A1
(43) Pub. Date: Nov. 13, 2025

(54) METHOD FOR OPERATING AN ELEVATOR FOR MAINTENANCE

(71) Applicant: Inventio AG, Hergiswil (CH)

(72) Inventor: Valerio Villa, Colverde (IT)

(21) Appl. No.: 18/862,571

(22) PCT Filed: May 8, 2023
(86) PCT No.: PCT/EP2023/062090

§ 371 Date: Nov. 4, 2024

(30) Foreign Application Priority Data
May 11, 2022 (EP) 22172866.0

(51) Int. Cl. B66B 5/00; B66B 5/02

(52) U.S. Cl. CPC B66B 5/0087; B66B 5/02; B66B 5/005

(57) ABSTRACT

A method operates an elevator for maintenance, wherein the elevator includes a car displaceable along an elevator shaft, a drive displacing the car, a brake temporarily braking the elevator car within the elevator shaft, a plurality of shaft doors, at least one of the shaft doors being arranged at each of multiple floors, and an elevator control unit having a car control unit and at least one door control unit to open/unlock one of the shaft doors. The elevator control unit is configured to be switched among a normal operation mode, a normal maintenance mode and a repair maintenance mode.

### FIELD

The present invention relates to a method for operating an elevator for maintenance. Furthermore, the present invention relates to an elevator configured for executing such a method, to a computer program product and to a computer-readable medium.

### BACKGROUND

An elevator comprises at least one car which may be displaced along an elevator shaft between multiple floors in a building using a drive engine. The car comprises at least one car door which may be opened and closed for providing and blocking access to the car, respectively. At each of the floors, at least one shaft door is provided which may be opened and closed for selectively providing or blocking access to the elevator shaft. The shaft doors are sometimes referred to as landing doors. As long as the car door is not coupled to a shaft door, the shaft door is generally locked in its closed state.

During maintenance of the elevator, a technician requires access to the elevator shaft in order to e.g. be able to inspect an integrity of components of the elevator comprised within the elevator shaft. For such purpose, in conventional elevators, the technician had to call the car to come near to one of the floors and set the elevator in state in which calls from the landing operation panels or a car operation panel were ignored. Then, the technician had to unlock the shaft door. For such unlocking, the technician had to use for example specific tools such as a triangular key. Then, the technician had to manually open the shaft door and e.g. get onto a roof of the waiting car. On the roof a control unit was typically provided. Using the control unit, the technician was able to control the drive engine while in maintenance mode for displacing the car to a desired location. Security measures had to be taken in order to guarantee that the technician was not hurt during such displacing action. For example, it had to be guaranteed that during the maintenance, the car was not driven to a location where the technician either on top of the car's roof or in the pit of the shaft was endangered. Finally, upon having completed the maintenance, the technician had to exit the elevator shaft and manually relock the associated shaft door.

Approaches for opening a locking of a landing door of an elevator are suggested in WO 2017/212105 A1, WO 2017/212106 A1 and WO2021/121905 A1.

### SUMMARY

There may be a need for an alternative method for operating an elevator for maintenance. Particularly, there may be a need for a method of operating an elevator for maintenance by which a safety level for the technician may be increased. Furthermore, there may be a need for an elevator, a computer program product and/or a computer-readable medium configured for implementing such a method.

These needs may be met with the subject-matter of one of the advantageous embodiments defined in the following specification.

According to a first aspect of the present invention, a method for operating an elevator for maintenance is proposed. Therein, the elevator comprises a car and an elevator shaft. The car is displaceable along the elevator shaft. The elevator further comprises a drive for displacing the car, a brake for temporarily braking the elevator car's displacement within the elevator shaft and a plurality of shaft doors. At least one of the shaft doors is arranged at each of multiple floors. The elevator comprises an elevator control unit comprising a car control unit and at least one door control unit for opening/unlocking one of the shaft doors. The elevator control unit is configured to be switched between a normal operation mode, a normal maintenance mode and a repair maintenance mode. The elevator control unit performs in the normal operation mode the following steps:
receiving a start-maintenance request, preferably sent by an external entity, wherein the external entity is preferably a mobile electronic device, preferably assigned to a technician; and
switching from normal operation mode to normal maintenance mode. The elevator control unit performs in the normal maintenance mode the following steps:
clearing of the unlocking/opening the shaft door via the at least one door control unit by the car control unit in response to the car reaching a predefined position.

The elevator control unit in the normal maintenance mode continuously performs the following steps:
detecting an inability to move the car; and/or
detecting a failure of the car control unit. In response to detecting an in inability to move the car and/or a failure of the car control unit the elevator control unit performs the following step:
switching from normal maintenance mode to repair maintenance mode.

The method steps are preferably executed in the indicated order. Continuously means above and in the following that the steps (detecting) are run till the condition is meet, i.e. in parallel to any other step, which the elevator might perform.

With this method, a safe access to the shaft for maintenance is enabled (normal maintenance mode). In contrast to prior methods the doors can not be opened with a triangular key but the opening/unlocking of the door is performed within the normal maintenance mode, i.e. the procedure run by the elevator control unit in the normal maintenance mode. This ensures that the shaft access is safer compared to the prior art methods, in which shaft access was possible at any elevator status by using a key. Such a normal maintenance method/maintenance access method is in detail described in the international patent application PCT/EP2021/081136 (WO 2022/101212 A1), as well as the European patent application 21218431.1 (EP 4 206 105 A1) which herewith are incorporated by reference. Furthermore, with a normal operation mode, in which access to the shaft is granted by the elevator control unit, it is essential to ensure that a repair maintenance mode is implemented, with which shaft access is possible even if due to an emergency state of the elevator the procedure in normal operation mode can not be performed/finished (also referred to as forced-check-in). In the herein described maintenance access concept, the position of the car is a precondition for unlocking/opening the shaft door within the normal operation. Therefore, if the car is not displaceable anymore or if the car control unit (master control unit), which is in charge of displacing the car does not work anymore (due to emergency), the access to the shaft has to be granted in a different way, i.e. with a modified procedure, i.e. the procedure run by the elevator control unit in the repair maintenance mode. It is important that also this procedure of granting access satisfies the security requirements and thus ensures that the elevator is safe.

Also important in this context (but not extensively discussed in this application) is to ensure a mode/method for a so called forced-checkout, i.e. to end shaft access in a safe way if the entity (e.g. technician), which requested access is not able to check-out of maintenance mode safely itself. This is discussed in the application European patent application 21218430.3 (WO 2023/126215 A1) which is herewith incorporated by reference.

A start-maintenance-request may be only an information that maintenance is requested. In a preferred embodiment the start-maintenance-request preferably contains information on where the maintenance is intended to take place and on what kind of maintenance is planned, so that the depending on the nature of the start-maintenance-request the elevator control unit knows where to displace the car to and where to expect the technician to enter the shaft.

A first entity might be in some cases synonymous with a first person, particularly with a first technician. For communication with the elevator the technician may be represented by a personal mobile electronic device, to which only he has access due to password or a fingerprint or any other equivalent security measure.

A mobile electronic device may be a smartphone or any similar device. Using such a device to send the start-maintenance-request and/or stop-maintenance-request allows to ensure that only the authorized technician who possesses such a device and who is able to unlock the device with a password, via a fingerprint-reader or any other unlock feature is able to send those requests.

The normal maintenance mode above and in the following refers to a mode which differs from the normal operation mode at least in that calls entered by passengers at landing operation panels and/or a car operation panel are ignored. Accordingly, during maintenance mode, the elevator may not provide any transportation services to passengers. Thus, during maintenance mode, there is no risk of the car being displaced in reaction to a passenger's call.

During normal operation mode, a shaft door shall exclusively be opened when the elevator car is parked adjacent to a shaft door. In such situation, the car door and the respective shaft door are aligned. However, in order to enable maintenance, exceptions from this rule have to be implemented within the maintenance mode. Particularly, a technician shall be able to access the shaft through a shaft door while the car is not parked directly adjacent to a shaft.

During the normal maintenance mode, the method shall ensure that the elevator shaft is only accessible to technician if the elevator shaft is safe. For this the elevator control unit, potentially among other method steps (such as verifying the presence of the technician at a respective floor or ensuring that there is no danger in a predefined danger zone) displaces the car into a safe position and engages the brake (preferably a car brake) to fix the car at this safe position, so that then a shaft door can be unlocked/opened for the maintenance to begin.

Now if it is a precondition to move the car to a predefined safe position in order to access the shaft, in cases in which the car cannot be moved due to an emergency case, there would be no shaft access at all in such an emergency case, as a manual opening of the shaft via a triangular key or any similar mean is intentionally not foreseen. The repair maintenance mode as above and in the following described is a mode to which the method switches to, in which the clearing of the shaft door via the door control unit can be done independently of the position of the car. It thus allows shaft access for maintenance work in emergency cases, in which the normal maintenance mode (access) fails.

Clearing the opening of the shaft door via the door control unit by the car control unit above and in the following refers to that the car control unit (which acts in a position of a master control unit) enables/allows/clears the door control unit (which acts in the position of a slave control unit) to unlock/open the shaft door. The door control unit as such preferably has all the needed intelligence and components (e.g. a door lock and/or a door drive unit) to open/unlock the shaft door but does only do so in response to receiving the clearance of the car control unit.

A predefined position may be a single fixed position, e.g. a position in the shaft head or pit or a position forming integral part of the start-maintenance-request, i.e. a variable position, which depends on the kind of maintenance that is requested by the external entity.

In preferred embodiment of the method for operating an elevator for maintenance the elevator comprises multiple door control units, wherein if the repair maintenance mode was switched to because of an inability to move the car, the car control unit further performs the following steps:
clearing the opening/unlocking of the shaft door via the at least one door control unit based on the status of the other door control unit/door control units.

In other words, in case the switching to the repair maintenance mode was triggered by the inability to move the car, the step of clearing the opening/unlocking of the shaft door via the at least one door control unit by the car control unit is then performed based on the door status of one or several other shaft doors/door control units. For this the door statuses preferably of all the shaft doors are sent to the car control unit by the respective door control unit.

Based on the status of the other door control unit/door control units (i.e., lock or opening status of the shaft door) the car control unit decides to clear the opening of the shaft door via the at least one door control unit. The car control unit may be configured such that it only clears the opening if no other shaft door is open. This enables a safe method for operating the elevator for maintenance, as it is avoided that people can enter the shaft at multiple locations.

In a preferred embodiment the elevator further comprises a car door, a load measuring system, slack detection system, a communication system, which enables at least the car control unit to communicate with the at least one door control unit, a positioning system, and/or a power supply. The method step of detecting an inability to move the car comprises:
detecting at least one of the failures out of the group consisting of a drive failure, a brake failure, a shaft door failure, a load measuring system failure, a slack detection system failure, a communication system failure, a positioning system failure, a car door failure and a power supply failure.

The above-mentioned components are alone or together relevant for the displacing the car. A failure of any of these systems thus impacts the ability of displacing the car safely. When the elevator is operated in the normal maintenance mode a failure of one or several of these components may impact the ability of the car to reach the predefined position. Therefore, a failure of one or several of these components is used a base to switch to the repair maintenance mode.

The components can all or mostly be connected to the car control unit, which monitors the functioning of these components. The car control unit thus at any point in time registers a failure of any of these components. Based on this, the control unit can then trigger the switch from normal maintenance mode into repair maintenance mode.

In a preferred embodiment of the method, wherein if the repair maintenance mode was switched to because of a failure of the car control unit, the at least one door control unit performs the following steps:
receiving an open-door-request; preferably sent by an external entity, wherein the external entity is preferably a mobile electronic device preferably assigned to a technician; and
opening/unlocking the respective shaft door by the at least one door control unit.

While in normal operation mode the method foresees that the car control unit is used to receive a start-maintenance request, in the repair maintenance mode, to which the method switched because of a failure of the car control unit, this task (receiving requests) is transferred to the door control unit.

This way the requests can still be received, and the shaft door opened, despite the failure of the car control unit.

In a preferred embodiment the elevator comprises multiple door control units. The at least one door control unit performs the following step:
clearing the unlocking/opening of the shaft doors via the respective door control unit.

If multiple door control units are present, one of the door control units can take over the master role from the failed car control unit and clear the opening/unlocking of the other shaft doors via the respective door control units. In other words, after the failure of the car control unit a door control unit is elected to be the new master control unit.

In a preferred embodiment the method further comprises the steps:
constantly sending messages from the car control unit to the door control unit timely spaced apart by a predefined first time period; and
concluding by the door control unit that the car control unit failed if more than one predefined time interval passes without the door control unit receiving the message.

In other words, a heart-beat between the car control unit and the at least one door control unit is implemented. Once the door control unit does not receive the heart-beat for a while, it can conclude that the car control unit (and/or the communication between them) must have failed. The first time period can for example be 10s, 30s or 1 min.

This allows the door control unit in a simple way to determine whether the car control unit is functioning and thus able to act as a master. In case it is not, the door control unit can take over the parts of the functioning of the car control unit, which are indispensable for maintenance access.

In a preferred embodiment the door control unit is connected to a landing operating panel of the elevator, which landing operating panel in normal operation mode is used as a passenger input panel. In the repair maintenance mode the door control unit further performs the steps:
detecting inputs to the landing operating panel; and
opening/unlocking the shaft door via the door control unit if an input into the landing operating panel and the open-door-request were detected/received by the door control unit. Preferably the input and the request were detected/received within a second predefined time period from each other.

This allows in case of a failure of the car control unit to implement additional security by verifying the presence of an external entity (i.e., a technician) close to the elevator. This way it is guaranteed, that the shaft door is only opened when both a request was sent, and the presence of the entity has been verified. The second time period can for example be 10s, 20s or 30s.

In a preferred embodiment of the method, at least if the repair maintenance mode was switched to because of the failure of the car control unit, the door control unit performs the following step:
persistently storing any performed door unlocking/opening actions.

Persistently above and in the following means that the information/data is permanently stored.

In this embodiment, the door control unit stores data regarding any unlocking/opening action controlled by the specific door control unit. As in the other operation modes this is done by the as master acting car control unit, it is important that in the repair maintenance mode triggered by the failure of the car control unit this task is taken care of by the door control unit. Based on the stored information it can be assured that any action relating to the door is registered and thus can be used to secure that other shaft doors are only opened once the already opened doors are closed again.

In a preferred embodiment the door control unit further performs the steps of:
continuously reevaluating of the car control unit's status by the at least one door control unit, preferably by continuously checking whether a message was received; and
wherein in response to concluding that that the car control unit functions again, the door control unit sends the data of the stored unlocking/opening actions to the car control unit.

After the car control unit works again, it is important for it to know the current status of the elevator in order to be able to take on its master tasks of orchestrating the opening of the shaft doors in a safe manner again. The door control unit thus sends the stored information to the car control unit, as soon as it realizes that the car control unit functions again (i.e., after having received another heart-beat).

According to a second aspect of the invention, an elevator is proposed, the elevator being configured to one of executing and controlling the method according to an embodiment of the first aspect of the invention.

In a preferred embodiment the elevator comprises a car being displaceable along an elevator shaft, a drive for displacing the car, a brake for temporarily braking the car's displacement within the elevator shaft, a plurality of shaft doors, at least one shaft door being arranged at each of multiple floors, and an elevator control unit. The elevator control unit comprises a car control unit and at least one door control unit to open/unlock one of the shaft doors. The elevator is configured to executing the method as described above and in the following.

In a preferred embodiment the elevator control unit, or at least as a part of it, of the elevator as described above and in the following is configured to fulfil SIL3 requirements.

In the elevator, all components participating in controlling the displacement of the car and/or opening the shaft doors may have to fulfil high safety requirements as defined in the SIL3 (Safety Integrity Level 3) standard. Accordingly, it may be guaranteed that no malfunctions in one of the components may result in creating potentially dangerous situations such as displacing the car while a technician is within the elevator shaft or opening a shaft door while no car has been driven to the predefined position close to the shaft door.

The elevator control unit or any part of it may be programmable. They may have for example a processor for executing computer-readable instructions and/or processing data and a memory for storing the instructions and/or data. Optionally, the door controller may be implemented within the elevator control unit or separate from it. In the latter case, two control units are connected with a data communication link.

In a preferred embodiment of the elevator each shaft door comprises a door control unit to open/unlock the respective shaft door, wherein the door control units are preferably wirelessly connected to the car control unit.

Preferably each of the shaft doors comprises an associated active door drive for opening and closing the shaft door and/or active door lock, which can be enabled/disabled by the door control unit.

An active door lock preferably is a door lock, with a rod and an actuator, preferably an electromagnetic actuator, to move the rod from a locking position into an unlocked position. The active door lock in a preferred embodiment includes a sensor to detect the locked and unlocked position.

In a preferred embodiment the brake is implemented as a car brake and/or the drive is implemented as a dual drive consisting of two separate drives.

The above and in the following described method for operating an elevator is especially useful if the brake is implemented as a car brake. As the security of the elevator while maintenance access/shaft access is granted by the described method, depends on the ability fix the car's position. Furthermore, the method is especially useful if the drive is implemented as a dual drive, as with such a system the likelihood of maintenance need at the drive can be higher and thus a method for operating/accessing the shaft during maintenance when the car can not be moved is required.

According to a third aspect of the invention, the computer program product comprises computer-readable instructions which, when performed by a processor in an elevator according to an embodiment of the second aspect of the invention, instructs the elevator to one of executing and controlling the method according to an embodiment of the first aspect of the invention. Alternatively, the computer program product comprises computer-readable instructions which, when performed by a processor in a mobile data communication device, instructs the mobile data communication device to transmit one of the requesting signals and the finalizing signal for triggering an elevator according to an embodiment of the second aspect of the invention to one of executing and controlling the method according to an embodiment of the first aspect of the invention.

In a preferred embodiment the computer program product comprises computer readable instructions which, when performed by a processor in an elevator as described above and in the following instructs the elevator to one of executing and controlling the method as described above and in the following. Or, alternatively, the computer program product comprises computer readable instructions which, when performed by a processor in a data communication device, instructs the data communication device to transmit a maintenance-request for triggering an elevator as described above and in the following to executing the method as described above and in the following.

A computer program product may be a form of an application (“App”) and may be used to instruct a mobile data communication device such as a smartphone to transmit one of the requesting signals and the finalizing signal for triggering an elevator such that the elevator executes or controls the method proposed herein.

The computer program product comprising the computer-readable instructions may be in any computer-readable language. Upon executing the computer-readable instructions, the elevator control unit performs or controls steps of the method proposed herein.

According to a fourth aspect of the invention, a computer-readable medium is proposed. The computer-readable medium has stored thereon a computer program product according to an embodiment of the third aspect of the invention.

A computer-readable medium comprising the computer program product described above stored thereon may be any portable computer-readable medium such as a CD, a CVD, a flash memory, etc. for transient or non-transient data storage. Alternatively, the computer-readable medium may be a computer or part of a computer network such as a cloud or the Internet, such that the computer program product may be downloaded therefrom.

It shall be noted that possible features and advantages of embodiments of the invention are described herein partly with respect to a method for operating an elevator for maintenance and partly with respect to an elevator configured for implementing such method. One skilled in the art will recognize that the features may be suitably transferred from one embodiment to another, and features may be modified, adapted, combined and/or replaced, etc. in order to come to further embodiments of the invention.

In the following, advantageous embodiments of the invention will be described with reference to the enclosed drawing. However, neither the drawing nor the description shall be interpreted as limiting the invention.

### DESCRIPTION OF THE DRAWINGS

FIG. 1 shows an elevator configured for executing a method for operating the elevator for maintenance according to an embodiment of the invention.

The figure is only schematic and not to scale. Same reference signs refer to same or similar features.

### DETAILED DESCRIPTION

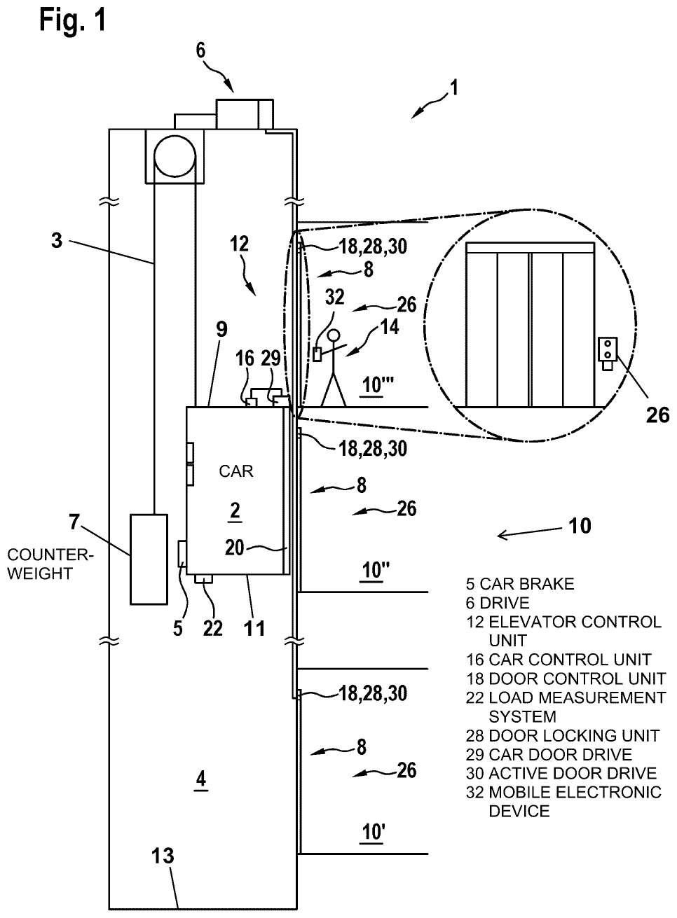

FIG. 1 shows an elevator 1. The elevator 1 is shown in a side view. Furthermore, a portion of the elevator 1 is shown in a front view, as visualized in a partial view inside a dashed frame line.

The elevator 1 comprises a car 2 which is displaceable along an elevator shaft 4. The elevator car 2 is held and displaced by a suspension traction means 3 such as a rope or a belt. At its opposite end, the suspension traction means 3 is coupled to a counterweight 7. The suspension traction means 3 is driven by a drive 6. The drive 6 is controlled by the elevator control unit 12. The elevator control unit 12 comprises a car control unit 16 and several door control units 18.

A brake system 5 in form of a car brake is attached to the car 2. Furthermore a load measurement system 22 can be found at the car 2. Further sensors, essential to determine the status of the elevator 1 are attached to the car 2 or arranged within the shaft 4 (not shown in the figure).

The elevator car 2 comprises a car door 20 for opening and closing an access to the elevator car 2. The car door 20 may be opened and closed actively by a car door drive 29. The car door drive 29 is controlled by the car control unit 16.

At each of multiple floors 10′, 10″, 10″′, generically floor(s) 10, at least one shaft door 8 is provided. The shaft door 8 may be opened and closed for granting or blocking access to the elevator shaft 4. The elevator 1 presented herein comprises an active door drive 30 at each of the shaft doors 8 for actively opening and closing the respective shaft door 8 by laterally displacing shaft door blades. Each of the door drives 30 is controlled by a respective door control unit 18. It is to be noted, that for reasons of a simpler terminology, the terms door drive 30 shall refer herein only to the shaft doors 8, not to the car door 20 (which is equipped with a car door drive 29).

Furthermore, at each of the multiple floors 10, a landing operation panel 26 is provided in proximity to the shaft door 8. For example, such landing operation panel 26 may comprise one or more push buttons which may be actuated by passengers for calling the car 2 to come to the respective floor 10.

During normal operation of the elevator 1, the elevator control unit 12 controls the drive 6 for displacing the car 2 to one of the floors 10 in response to passengers' call provided by actuating one of the landing operation panels 26. Therein, the drive 6 is controlled such that the car 2 is stopped at the landing position such that its car bottom 11 is substantially on the same height as a bottom at the floor 10 at which the car 2 shall collect or deliver passengers.

For maintenance purposes, the normal operation of the elevator 1 has to be temporarily interrupted. For such purpose, according to the method proposed herein, the technician 14 (first entity) may approach the elevator 1 at one of the floors 10, such as for example the uppermost floor 10′″. Upon being close to the shaft door 8 at this floor 10″′, the technician 14 may send a request for maintenance. Such a request is then received by the elevator control unit 12.

When the elevator control unit 12 has received a maintenance-request sent by the technician 14, the drive 6 will attempt the displacement of the car 2 to a predefined position such that, for example, a roof 9 of the car 2 is adjacent to the shaft door 8 at the floor 10 at which the maintenance work requested in the maintenance-request has to be performed (for example the uppermost floor 10″′, as show in FIG. 1).

As for another example, when the maintenance-request is such that maintenance at the lowermost floor 10′ is requested, the drive 6 will attempt to displace the car 2 based on a control of the elevator control unit 12 to a position above the lowermost floor 10′, i.e. such that the car bottom 11 is sufficiently above a pit 13 of the elevator shaft 4, for allowing the technician 14 to enter such a pit 13. Subsequently, the elevator control unit 12 would control the door drive 30 of the lowermost floor 10′ to actively open the associated shaft door 8. The technician 14 may then enter the pit 13. In the pit 13, the technician may inspect, modify, repair, or replace various components of the elevator 1.

Upon having received the request for maintenance (start-maintenance-request), the elevator control unit 12 switches to normal maintenance mode. In such normal maintenance mode, calls entered by passengers for example on one of the landing operation panels 26 at any of the other floors 10 or at a car operation panel (not shown) are ignored.

In an exemplary, the technician 14 may use a mobile electronic device 32 such as a smartphone to generate and transmit data forming the maintenance-request. For such purpose, a specific application may be programmed and uploaded to the mobile electronic device 32. The electronic mobile device 32 may send electromagnetic waves encrypting the maintenance-request. The electromagnetic waves may be received by a suitable sensor being part of or being connected to the elevator control unit 12. Alternatively, the communication link between the mobile electronic device 32 and the elevator control unit 12 could also be established via a server, e.g. a cloud.

As in the normal maintenance mode, the elevator control unit 12, in particular the car control unit 16 monitors the functioning of the different (safety relevant) systems, which are relevant to perform the above-mentioned maintenance “check-in” such as the brake system 5 and/or the load measurement system 22, etc. If it is determined that due to a failure of any of these systems, the before described move of the car 2 to the predetermined position (which is essential to enter the maintenance mode) is not possible, the elevator control unit 12 switches to the repair maintenance mode. Such a repair maintenance mode is essential for an elevator 1, which relies on the function of at least part of its components to access the normal maintenance mode. So the repair maintenance mode has to be switched to whenever no functioning normal maintenance mode is reachable/executable.

Two categories of failures can be distinguished, in which a switch to a repair maintenance mode is required: First if an inability to move to car 2 is detected. Second, if the car control unit 16 fails.

In the first case, if the car 2 can not be moved to the predefined position, the check-in procedure will not be completed, and the shaft door 8 will not open. Thus the technician 14 can not access the shaft 4. In this case, to nevertheless open the shaft door 8, the elevator can rely on information and help of the car control unit 16 (master control). The car control unit 16 is updated with the opening/unlocking of each of the multiple shaft doors 8 (i.e. of the status of the respective door control units 18) at any mode of operation (normal operation, normal maintenance mode and preferably also during the repair maintenance mode). The car control unit 16 can thus in the repair maintenance mode help to assure that only one of the door control units 18 opens/unlocks at any given time and thus help increase the safety of the elevator 1 (i.e. the maintenance of the elevator). To do so the car control unit 16 can clear the opening of one of the shaft doors 8 via clearing the opening process with the respective door control unit 18, e.g. the door control unit 18 on the uppermost floor 10″′. The door control unit 18 can then, for example, be enabled to communicate directly to a mobile device 32 of the technician 14. The technician 14 can request the opening of the shaft door 8 via the mobile device 32 and the cleared door control unit 18 can then independently of any other requirements open/unlock the respective shaft door 8. The technician 14 is thus granted access to the shaft 4 and can start the maintenance. The door control unit 18 can save this performed action.

In the second case the car control unit 16 fails and is thus not available as a master control to additionally secure the opening of a shaft door 8. In this case the elevator 1 can be preconfigured to allow one or several door control units 18 to communicate directly to the mobile device 32 of the technician 14 and to perform the opening of the shaft door 8 independently of any other control unit. In an embodiment at the failure of the car control unit 16, one of the door control units 18, e.g. the door control unit 18 on the uppermost floor 10″′ can inherit the master function and then be the one door control unit 18, which the mobile device 32 can connect to (i.e. a predefined master election can take place).

Finally, it should be noted that the term “comprising” does not exclude other elements or steps and the “a” or “an” does not exclude a plurality. Also, elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for operating an elevator for maintenance of the elevator, wherein the elevator includes a car in an elevator shaft, the car being displaceable along the elevator shaft, a drive displacing the car along the elevator shaft, a brake temporarily braking the elevator car within the elevator shaft, a plurality of shaft doors, at least one of the shaft doors being arranged at each of multiple floors along the elevator shaft, an elevator control unit including a car control unit and at least one door control unit for opening/unlocking one of the shaft doors, wherein the elevator control unit is configured to be switched among a normal operation mode, a normal maintenance mode and a repair maintenance mode, the method comprising the following steps:
wherein the elevator control unit in the normal operation mode performs the steps of receiving a start-maintenance request, and switching from the normal operation mode to the normal maintenance mode in response to the start-maintenance request;
wherein the elevator control unit in the normal maintenance mode performs the step of clearing of an unlocking/opening the one shaft door via the at least one door control unit by the car control unit in response to the car reaching a predefined position in the elevator shaft;
wherein the elevator control unit in the normal maintenance mode continuously performs the steps of detecting an inability to move the car in the elevator shaft and/or detecting a failure of the car control unit; and
in response to detecting the inability to move the car in the elevator shaft and/or the failure of the car control unit the elevator control unit performs the step of switching from the normal maintenance mode to the repair maintenance mode.

17. The method according to claim 16 including receiving the start-maintenance request from an external entity.

18. The method according to claim 17 wherein the external entity is a mobile electronic device assigned to a technician authorized to access the elevator shaft.

19. The method according to claim 16 wherein the elevator includes multiple door control units and when the repair maintenance mode is switched to because the inability to move the car in the elevator shaft was detected, the car control unit performs the step of clearing the opening/unlocking of the one shaft door via the at least one door control unit based on a status of all others of the multiple door control units.

20. The method according to claim 16 wherein the step of detecting an inability to move the car includes detecting at least one failure out of a group including a drive failure, a brake failure, a shaft door failure, a load measuring system failure, a slack detection system failure, a communication system failure, a positioning system failure, a car door failure and a power supply failure.

21. The method according to claim 16 wherein when the repair maintenance mode is switched to because the failure of the car control unit was detected, the at least one door control unit performs the steps of receiving an open-door-request, and opening/unlocking the one shaft door by the at least one door control unit in response to the open-door-request.

22. The method according to claim 21 including receiving the open-door-request from a mobile electronic device assigned to a technician authorized to access the elevator shaft.

23. The method according to claim 21 wherein the elevator includes multiple door control units each associated with one of the shaft doors and the at least one door control unit performs the step of clearing the unlocking/opening of the shaft doors via the associated ones of the door control units.

24. The method according to claim 16 including the steps of:
constantly sending messages from the car control unit to the at least one door control unit timely spaced apart by a predefined first time period; and
concluding by the at least one door control unit that the car control unit failed when more than one predefined time interval passes without the at least one door control unit receiving one of the messages.

25. The method according to claim 24 wherein the at least one door control unit is connected to a landing operating panel of the elevator, the landing operating panel in normal operation mode being a passenger input panel, and when in the repair maintenance mode the at least one door control unit performs the steps of:
detecting inputs to the landing operating panel; and
opening/unlocking the one shaft door via the at least one door control unit when an input into the landing operating panel is detected and an open-door-request is received by the at least one door control unit, the input and the open-door-request being detected and received respectively within a predefined second time period from each other.

26. The method according to claim 16 wherein when the repair maintenance mode is switched to because of the failure of the car control unit, the at least one door control unit performs the step of persistently storing any performed door unlocking/opening actions.

27. The method according to claim 26 wherein the at least one door control unit further performs the steps of:
continuously reevaluating a status of the car control unit by continuously checking whether a message is received from the car control unit; and
when the status of the car control unit has changed from a failure status to a functioning status, sending data of the stored unlocking/opening actions to the car control unit.

28. An elevator comprising:
a car in an elevator shaft, wherein the car is displaceable along the elevator shaft;
a drive displacing the car along the elevator shaft;
a brake temporarily braking the car within the elevator shaft;
a plurality of shaft doors, at least one of the shaft doors being arranged at each of multiple floors along the elevator shaft; and
an elevator control unit including a car control unit and at least one door control unit to open/unlock one of the shaft doors, wherein the elevator control unit performs the method according to claim 16.

29. The elevator according to claim 28 wherein each of the shaft doors has a door control unit to open/unlock the respective shaft door, and wherein the door control units are wirelessly connected to the car control unit.

30. The elevator according claim 28 wherein the brake is car brake and/or the drive is a dual drive consisting of two separate drives.

31. The elevator according claim 28 wherein each of the shaft doors has at least one of a door control unit, a door locking unit and a door drive.

32. A computer program product comprising computer readable instructions that, when stored on a non-transitory computer-readable medium and performed by a processor in an elevator, instruct the elevator to perform the method according to claim 16.

33. A non-transitory computer-readable medium comprising the computer program product according to claim 32 stored thereon.

34. A computer program product comprising computer readable instructions that, when stored on a non-transitory computer-readable medium and performed by a processor in a mobile electronic device, instructs the mobile electronic device to transmit a start-maintenance request to an elevator to cause the elevator to perform the method according to claim 16.

35. A non-transitory computer-readable medium comprising the computer program product according to claim 34 stored thereon.
